(19) United States
(12) Patent Application Publication
(10) Pub. No.: US 2008/0016957 A1
(43) Pub. Date: Jan. 24, 2008

(54) Mass flow meter

(76) Inventor: Isao Suzuki, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/819,244

(22) Filed: Jun. 26, 2007

(30) Foreign Application Priority Data
Jul. 21, 2006 (JP) 199171/2006

(51) Int. Cl. G01F 1/684

(52) U.S. Cl. 73/204.21

(57) ABSTRACT

A mass flow meter has a range of flow rate measurement that can be enlarged by changing of the structure of a sensor portion without modification of a bypass portion. The mass flow meter includes a sensor tube 5 through which fluid is transmitted while being heated, the flow meter being adapted to detect a mass flow rate of the fluid, based on a change in temperature distribution in the narrow sensor tube 5 that occurs according to the mass flow rate of the fluid, the flow meter comprising a flow restriction channel 7 for the fluid that is disposed in series with the narrow sensor tube 5.

### CROSS REFERENCE TO RELATED APPLICATION

The present application claims priority under 35 U.S.C. section 119 to Japanese Patent Application No. 2006-199171, filed Jul. 21, 2006, which is herein incorporated by reference in its entirety for all purposes.

### BACKGROUND OF THE INVENTION

1. Technical Field

The present invention relates to a mass flow meter, in particular, a thermal mass flow meter adapted to detect a mass flow rate, based on a change in a temperature distribution in a sensor tube that occurs when a fluid is passed through the sensor tube while the sensor tube is heated.

2. Related Art

Conventionally, as disclosed, for example, in U.S. Pat. Nos. 5,044,199 and 5,804,717, in order to broaden a measurable range of flow rate, a technique of providing a bypass portion in a flow channel of a mass flow meter, the bypass portion being disposed in parallel with a flow sensor, is adopted. U.S. Pat. Nos. 5,044,199 and 5,804,717 are all hereby incorporated by reference in their entirety.

Thermal mass flow sensors have a dynamic range: about 1:1000. For a flow rate exceeding this measurable range, a bypass portion is disposed to divide a flow, so as to increase a measurable range of a flow meter. The measurable range of a mass flow sensor having a sensor tube is several tens of cubic centimeters/minute. With a bypass portion being used, however, the measurable range can exceed over 100 liters/minute.

A fluid, for example, air passing through the bypass portion, can maintain a laminar flow up to a Reynolds number of several thousand. Therefore, a considerably broad range of flow velocity can be used in practice. On the other hand, the usable range of flow velocity of fluid passing through a sensor portion is small, due to a problem that a sufficient heat exchange between the fluid and the sensor tube cannot be maintained at higher flow velocity. For example, suitable Reynolds number of air is only several tens at conventional sensor tube. Due to this imbalance, an operation must be conducted at a low differential pressure by providing another large bypass to reduce the flow velocity in the sensor tube although the practical range of flow velocity in the bypass portion is actually larger.

In other words, a considerable number of bypasses for obtaining same flow velocities at sensor tube are needed to broaden a measurable range for the purpose of obtaining a prescribed range of flow rate measurement.

### SUMMARY OF THE INVENTION

The present invention is made in view of the above-described problem. An object of the present invention is to broaden a measurable range of flow rate, while preventing increase the number of required bypasses. Another object of the present invention is to expand a measurable flow rate without saturating the sensor output.

A mass flow meter of the present invention includes a sensor tube through which fluid is transmitted while being heated, the flow meter being adapted to detect a mass flow rate of the fluid, based on a change in temperature distribution in the sensor tube that occurs according to the mass flow rate of the fluid, the flow meter comprising a flow restriction channel for the fluid that is disposed in series with the sensor tube.

A mass flow meter of the present invention is characterized in that the flow restriction channel is selected from a plurality of flow restriction channels each having a different fluid conductance.

A mass flow meter of the present invention further comprises a fluid bypass portion having a predetermined conductance, the fluid bypass portion being disposed in parallel with the narrow sensor tube, wherein the flow restriction channel is provided in a part of the fluid bypass portion.

### BRIEF DESCRIPTION OF THE DRAWINGS

Referring now to the attached drawings which form a part of this original disclosure:

FIG. 1 is a cross sectional view of a mass flow meter according to a first embodiment of the present invention.

FIG. 2 is a perspective view of a fluid bypass portion used in the mass flow meter according to the first embodiment of the present invention.

FIG. 3 is an exploded, perspective view showing a flow restriction channel used in the mass flow meter of the first embodiment of the present invention.

FIG. 4 shows a conductance of each portion of the mass flow meter of the present invention.

FIG. 5 is an example of outputs of the mass flow meter of the first embodiment of the present invention and a conventional mass flow meter.

FIG. 6 is a cross-sectional view of a mass flow meter according to a second embodiment of the present invention.

FIG. 7 is a perspective view of a fluid bypass portion used in the mass flow meter of the second embodiment of the present invention.

### DETAILED DESCRIPTION OF THE PREFERRED EMBODIMENTS

Below, embodiments of the mass flow meter of the present invention will be described with reference to accompanying figures. In the figures, like elements are denoted by like reference numerals, and redundant descriptions are omitted.

### Embodiment 1

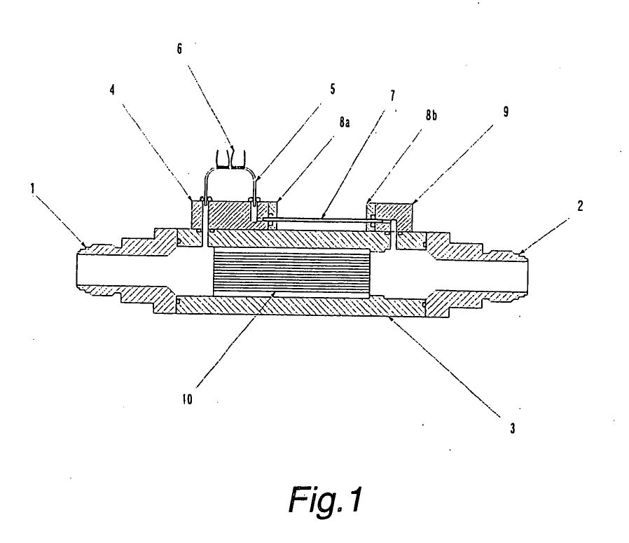

FIG. 1 is a cross-sectional view of the mass flow meter according to embodiment 1 of the present invention. The mass flow meter comprises: a main body 3 having a main flow channel; and an inlet block 1 connected via an O-ring to the left side of the main body 3; and an outlet block 2 connected via an O-ring to the right side of the main body 3.

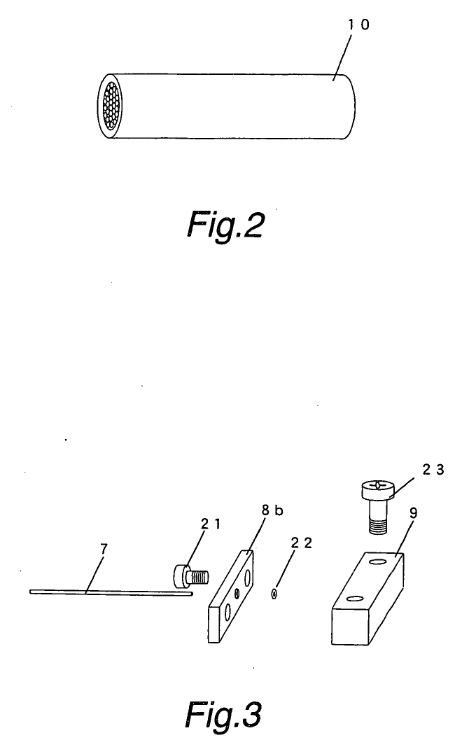

The main body 3 is provided with a fluid bypass portion (selectable fluid bypass portion) 10, as shown in FIG. 2, that is pressed into a cylindrical interior of the main body 3 and disposed approximately at the center of the main flow channel. The fluid bypass portion 10 comprises a plurality of tubes with a small diameter, the tubes being bundled together and fitted into an outer tube with a large diameter, and functions as a laminar flow element.

A first port that communicates with a sensor tube 5 is formed in a portion of a ceiling of the main body 3 slightly in front of a front end of the fluid bypass portion 10 on a side of the inlet block 1, and another second port is formed in a portion of the ceiling of the main body 3 slightly behind a rear end of the fluid bypass portion 10 on a side of the outlet block 2. Further, a sensor flange 4 and a flow-restriction-channel flange 9 are connected via O-rings to positions of the first and second ports of the main body 3.

The sensor flange 4 comprises an inlet port and an outlet port through which fluid is transmitted, the inlet and outlet ports being formed in a vertical direction of the figure. The inlet and outlet ports are connected to, for example, a U-shaped metal sensor tube 5 having an inner diameter of 0.3 mm, connected portions being sealed by O-rings. The sensor tube 5 is provided with a pair of resistive temperature detectors 6 that are made from resistance wire wound around portions of the sensor tube 5 on a fluid upstream side and a fluid downstream side. A pair of temperature detectors 6 is heated by electrical current source. In order to detect a mass flow rate using the resistive temperature detectors 6, a structure such as disclosed, for example, in Japanese Patent No. 3229138 is used. Japanese Patent No. 3229138 is hereby incorporated by reference in its entirety.

The outlet port of the sensor flange 4 comprises: a vertical flow channel communicating with the sensor tube 5; and a horizontal flow channel communicating with a flow-restriction-channel 7 made by fine metal tube. Similarly, the flow-restriction-channel flange 9 comprises a vertical flow channel that communicates with the second port on the main body 3 and a horizontal flow channel that communicates with the other side of above-mentioned flow-restriction-channel 7. The horizontal flow channel of the sensor flange 4 and the horizontal flow channel of the flow-restriction-channel flange 9 have O-ring sealed connection to each side of flow-restriction-channel supported by covering members 8a and 8b.

FIG. 3 shows a structure in which the flow-restriction-channel 7 is connected to a horizontal port of the flow-restriction-channel flange 9. The covering member 8b is attached to the flow-restriction-channel flange 9 with two screws 21 and same as covering member 8a to sensor flange 4. Only one of the two screws 21 is shown in FIG. 3. An O-ring 22 is fitted into the opening formed at the central portion of the covering member 8b through which the end of the flow-restriction-channel 7 is passed, so as to seal a portion connecting flow-restriction-channel 7 and the horizontal port of the flow-restriction-channel flange 9. A screw 23 is used to connect the flow-restriction-channel flange 9 to the main body 3.

Flow rates that can be measured by the flow meter are determined by conductance's of the flow restriction-channel 7, the sensor tube 5 and a conductance of the fluid bypass portion 10 selectively pressed into the flow meter according to a target flow rate to be measured. The conductance of the flow-restriction-channel 7 can be properly changed by selecting a flow-restriction-channel 7 from a plurality of flow-restriction-channels each having a different internal diameter of the flow channel or a different length of the flow channel, so as to readily deal with a wide range of measurement, which has not been able to be achieved by a conventional device. In this embodiment, a metal tube having inner diameter 0.2 mm, outer diameter 11.0 mm, length 40 mm is used for the flow-restriction-channel.

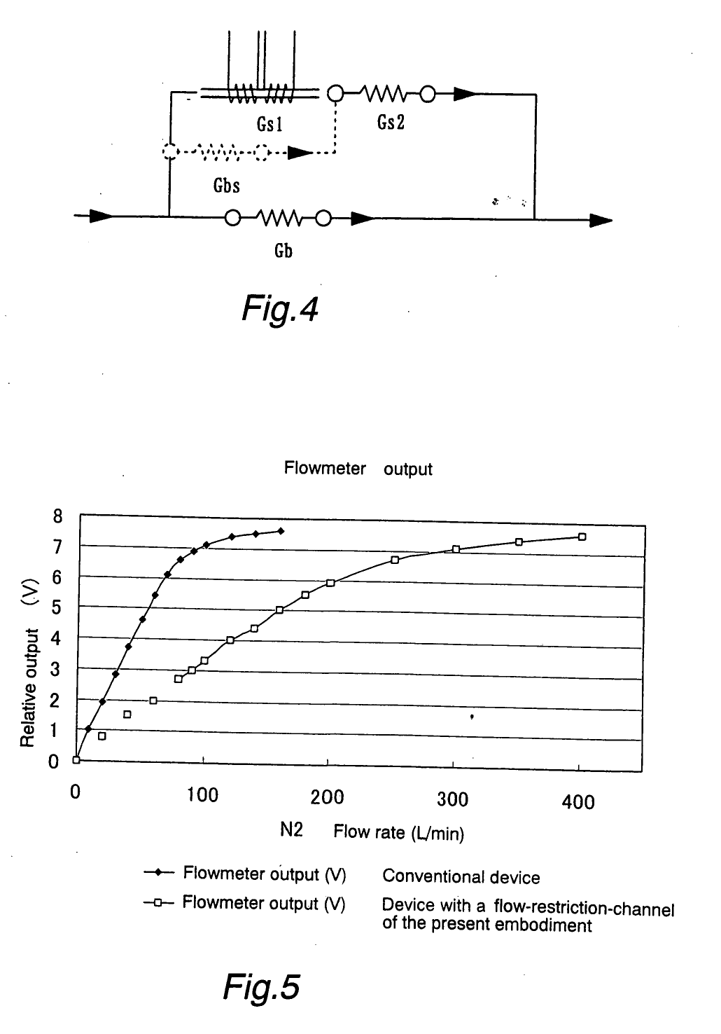

Given that the conductance of the fluid bypass portion 10 is Gb, the conductance of the sensor tube 5 of the sensor portion is Gs1, and the conductance of the flow-restriction-channel 7 is Gs2, as shown in FIG. 4, the conductance Gt of the flow meter is represented by equation 1 below:

$$Gt = Gb + Gs 1 \cdot \frac{1}{1 + Gs 1 / Gs 2} \qquad Equation 1$$

As is clear from Equation 1 above, the conductance Gs of the sensor portion is represented by the second term on the right side of the equation and can be decreased depending on the ratio of Gs1 to Gs2. In other words, an output of the mass flow meter can be prevented from saturating due to an excessive amount of fluid flowing through the sensor tube 5. A flow meter capable of measuring a required flow rate can be readily obtained by placing a flow-restriction-channel 7 with a predetermined size selected according to the conductance Gs2 of the flow-restriction-channel 7. The flow rate Q of a fluid with a differential pressure Dp applied to the flow meter is represented by equation 2 below:

$$Q = Dp \cdot Gs 1 ( \frac{Gb}{Gs 1} + \frac{1}{1 + Gs 1 / Gs 2} ) \qquad Equation 2$$

Equation 2 representing the flow rate Q shows that the conductance can be increased approximately by a factor of Gb/Gs1 without saturating the output of the mass flow meter. Therefore, a large flow rate can be measured. In contrast, the flow rate Q of a conventional example without the conductance Gs2 of the flow-restriction-channel 7 is represented by equation 3 below:

Q=Dp*(Gs1+Gb) Equation 3

Since Gb>>Gs1 in equation 3, the flow rate of the conventional example is virtually determined by Gb only.

Therefore, a technique of changing the conductance Gb of the fluid bypass portion 10 is adopted to change the flow rate.

FIG. 5 shows an example of outputs of the mass flow meter of the present embodiment and a conventional device. The output of the conventional device is saturated below 100 L/min. With the flow-restriction-channel 7 of the present embodiment, however, a desirable output linearity can be obtained up to 200 L/min. In other words, a wide range of flow rate can be measured without changing the structure of the fluid bypass portion 10.

The mass flow meter of the present invention is adapted to detect a mass flow rate of fluid, based on a change in temperature distribution in the sensor tube through which the fluid is transmitted while being heated, the flow meter comprising a flow restriction channel for the fluid that is disposed in series with the sensor tube. In this way, the conductance of the sensor portion is restricted by the conductance of flow restriction channel. Therefore, without depending on the fluid bypass portion, it is possible to provide a mass flow meter having a wide dynamic range by making it difficult for fluid to flow into the sensor tube, to prevent the output of the mass flow meter from saturating. Further, in a case that the flow restriction channel is replaced with one of various flow restriction channels to obtain a desirable range of flow rate of the mass flow meter, the number of required bypasses can be reduced. As a result, production costs can be reduced.

### Embodiment 2

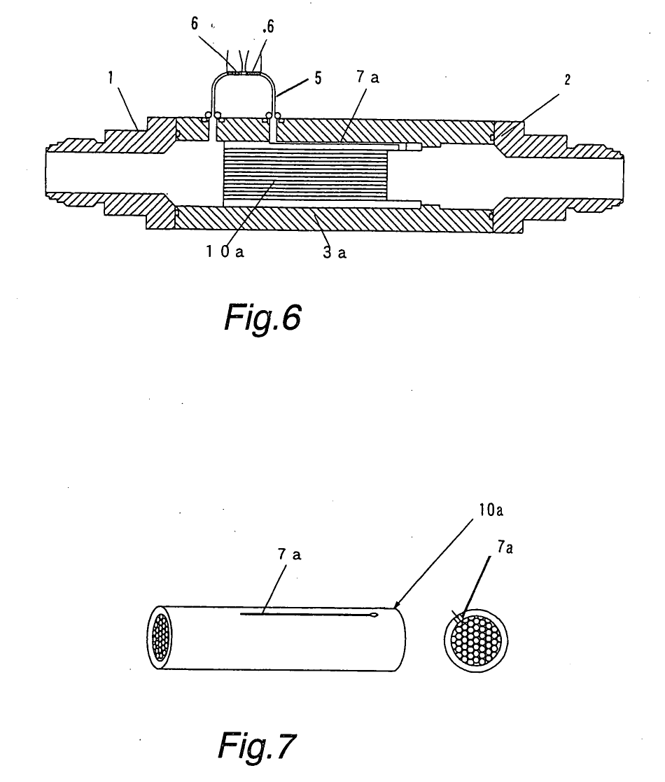

FIG. 6 shows the second embodiment, and FIG. 7 shows the structure of a flow-restriction-channel 7a. In the present embodiment, the flow-restriction-channel 7a, which is disposed in series with a sensor tube 5, is made from a groove formed in a part of a fluid bypass portion (selectable fluid bypass portion) 10a. The groove is made easily by conventional means such as mechanical milling or chemical etching.

In the present embodiment, a first port that communicates with a sensor tube 5 is formed in a portion of a ceiling of the main body 3a slightly in front of a front end of the fluid bypass portion 10a on a side of the inlet block 1, and another second port is formed in a portion of the ceiling of the main body 3a corresponding to a front end of the groove formed in the fluid bypass portion b1a. Further, a sensor tube 5 is connected via O-rings to the positions of the above-described ports (first and second ports) of the main body 3a.

According to the present embodiment, the effects of the first embodiment can also be obtained by the present embodiment. That is, the conductance of the flow-restriction-channel 7a can be properly changed by using a fluid bypass portion 10a having a different groove seize such as groove depth or groove length, to readily deal with a wide range of measurement, which has not been able to be achieved by a conventional device.

Further, according to the present embodiment, another sensor-bypass-channel is easily formed between both ports of a sensor tube 5, by extending the groove on the fluid bypass portion to the location of inlet port of the main body 3a. In this case, fluid flow that passes to the sensor tube 5 is reduced by the bypass conductance Gbs of sensor-bypass-channel which is indicated with dotted line in FIG. 4. Therefore flow meter can expand its measuring range easily by selecting seize of the grooves for the area where fluid is passing in parallel with sensor tube 5 (corresponding to Gbs in FIG. 4) and in series with the sensor tube 5 (corresponding to Gs2 in FIG. 4) respectively.

Since certain changes and modifications can be made in the above embodiments without departing from the scope of the invention as defined in the appended claims. Further, the foregoing descriptions of the embodiments according to the present invention are provided not for the purpose of limiting the invention as defined by the appended claims and their equivalents.

What is claimed is:

1. A mass flow meter including a sensor tube through which fluid is transmitted while being heated, the flow meter being adapted to detect a mass flow rate of the fluid, based on a change in temperature distribution in the narrow sensor tube that occurs according to the mass flow rate of the fluid, the flow meter comprising at least
a flow restriction channel for the fluid that is disposed in series with the sensor tube.

2. A mass flow meter according to claim 1, wherein the flow restriction channel is selectable from a plurality of flow restriction channels each having a different fluid conductance.

3. A mass flow meter including a sensor tube through which fluid is transmitted while being heated, the flow meter being adapted to detect a mass flow rate of the fluid, based on a change in temperature distribution in the sensor tube that occurs according to the mass flow rate of the fluid, the flow meter comprising at least
a flow restriction channel for the fluid disposed in series with the sensor tube and,
a fluid bypass portion for the fluid disposed in parallel with the sensor tube.

4. A mass flow meter according to claim 3, wherein the flow restriction channel is selectable from a plurality of flow restriction channels each having a different fluid conductance.

5. A mass flow meter according to claim 3, a flow restriction channel is provided in a part of the fluid bypass portion.

6. A mass flow meter according to claim 3, further comprising at least a sensor bypass channel that makes a fluid bypass between both edges of the sensor tube.

7. A mass flow meter including a sensor tube through which fluid is transmitted while being heated, the flow meter being adapted to detect a mass flow rate of the fluid, based on a change in temperature distribution in the sensor tube that occurs according to the mass flow rate of the fluid, the flow meter comprising at least
a flow restriction channel for the fluid disposed in series with the sensor tube and,
a selectable fluid bypass portion, disposed in parallel with the sensor tube, in a part of which the flow restriction channel is structured.

8. A mass flow meter according to claim 7, further comprising at least a sensor bypass channel, that makes a fluid bypass between both edges of the sensor tube, which is structured in a part of the selectable fluid bypass portion.
